(19) United States
(12) Patent Application Publication
(10) Pub. No.: US 2003/0171952 A1
(43) Pub. Date: Sep. 11, 2003

(54) System and method for assessing quality of life

(76) Inventors: Annika Nordgaard Burrild, Hornbackvej (DK); Linette Nordgaard Blok, Alsgarde (DK); Sascha Nina Nordgaard Fabricius, Saksksbing (DK); Preben Nordgaard Hansen, Alsgarde (DK)

Correspondence Address: CROCKETT & CROCKETT, 24012 CALLE DE LA PLATA, SUITE 400, LAGUNA HILLS, CA, 92653, US

(21) Appl. No.: 10/095,891

(22) Filed: Mar. 11, 2002

(51) Int. Cl. G06F 17/60

(52) U.S. Cl. 705/2

(57) ABSTRACT

A system and method for assessing quality of life and its development by systematically evaluating a set of selected parameters and displaying the evaluation results over time. The method and the system help to assess a success factor calculated from the evaluated parameters. The parameters may be self-defined or chosen from predefined templates. The user may be automatically requested to evaluate the selected set of parameters at certain intervals.

### FIELD OF THE INVENTIONS

The present invention relates to a system and method for assessing an individual's quality of life by monitoring fulfillment of a selected set of criteria by means of a data processor and software.

### BACKGROUND OF THE INVENTIONS

People assess their quality of life according to objective and subjective criteria. For example, many people write down New Years Resolutions identifying different aspects of their life that they would like to change, such as smoking, lying, etc. Most people are more likely to improve their quality of life if they track their progress using a set of criteria according to what they deem important to their own success and quality of life. So far, no tool has been provided to systematically assist people in this assessment.

Questionnaires have been provided to assess quality of life by means of a scheme such as “Assess your own personal quality of life” by Diana Chaudhuri. This questionnaire, filled in via the Internet, only provides a means of assessing a person's quality of life at the point in time of answering the questionnaire with no means for tracking or controlling development of the quality of life over time. A questionnaire to assess quality of life in the elderly was developed under the auspices of the European Office of the World Health Organization: “LEIPAD, an internationally applicable instrument to assess quality of life in the elderly”. This questionnaire has been used by medical doctors to survey the quality of life of the elderly and is based on a medical doctor evaluating the answers with no data processor to encourage the user to follow up on the results.

### SUMMARY

The system and method described below systematically assesses quality of life and monitors its development. The user may self-define what parameters (or criterion) he wishes to measure by entering the parameters or choosing ones that are pre-defined. Parameters are selected and monitored in a time weighted manner preferably by using a formula taking into account the previous value of a parameters evaluated. Results of the evaluation of a selected group of parameters are plotted in a graph showing the development over time. A success factor is calculated from the evaluation of a selected group of parameters and is also plotted in a time weighted manner. The program may be used for self-assessment, to assess others, and to request assessment from others. The program may automatically remind the user to evaluate the selected criteria.

### BRIEF DESCRIPTION OF THE DRAWINGS

FIG. 1 illustrates an exemplary screen having a field for selecting a set of parameters used to calculate the user's quality of life, and having a field to evaluate the selected set of parameters.

FIG. 2 illustrates an exemplary screen displaying a plotted graph of parameter values selected and calculated over time.

FIG. 3 illustrates an exemplary screen displaying a plotted graph of the calculated success factor value over time.

FIG. 4 illustrates an exemplary screen for selecting the system settings.

FIG. 5 illustrates an exemplary screen for selecting the network options.

FIG. 6 illustrates one embodiment of the operational flow of the software used to collect parameter values for the calculation of Pi new.

### DETAILED DESCRIPTION OF THE INVENTIONS

The term “quality of life” as described herein is based on any aspect that a person might consider as contributing to an aspect of his or her well being, such as social performance, family life, job performance, inner spiritual or aesthetic values, relationships with other people, etc. Quality of life is measured by a calculated success factor derived from designation of selected parameters.

The system comprises a data processing means, which can be any type of general-purpose computer, such as a personal computer (PC), workstation, handheld computer, electronic personal assistant or mobile phone. The operating system may be any kind of commercially available software package, such as Linux, Windows (XP, NT, ME, CE), Mac OS, PalmOS, EPOC, etc. The system further has a means for storing parameter values, such as a hard disc, flash memory or any other memory. The system further comprises a data input interface, such as a keyboard, keypad, touch screen, or mouse, and a data output interface such as a computer screen, television screen, or any other display. The invention will hereinafter be described with a PC as the data processing means, keyboard and mouse as the data input interface, and computer screen as the data output interface.

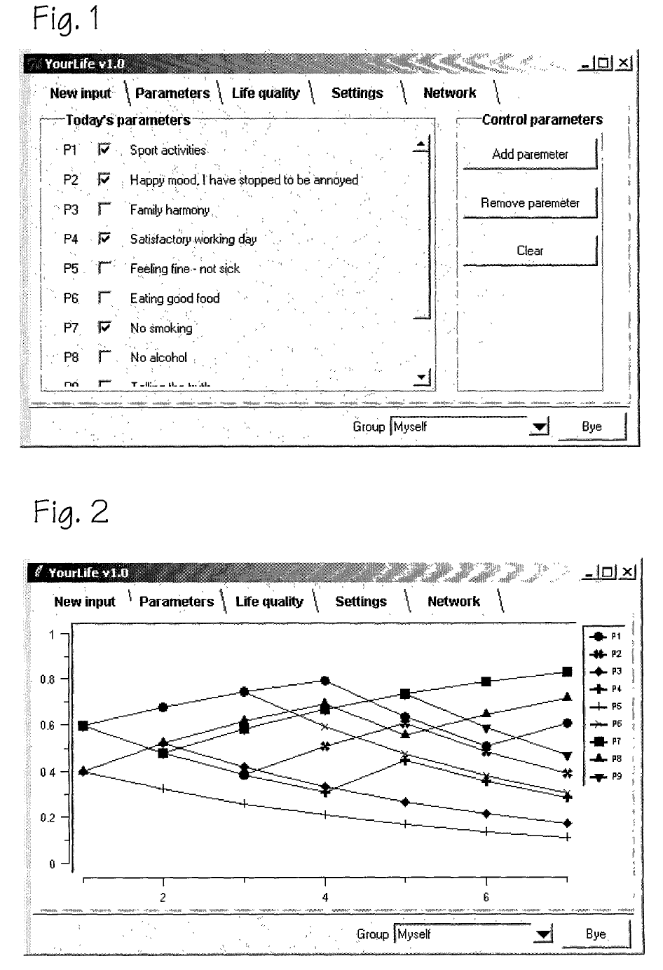

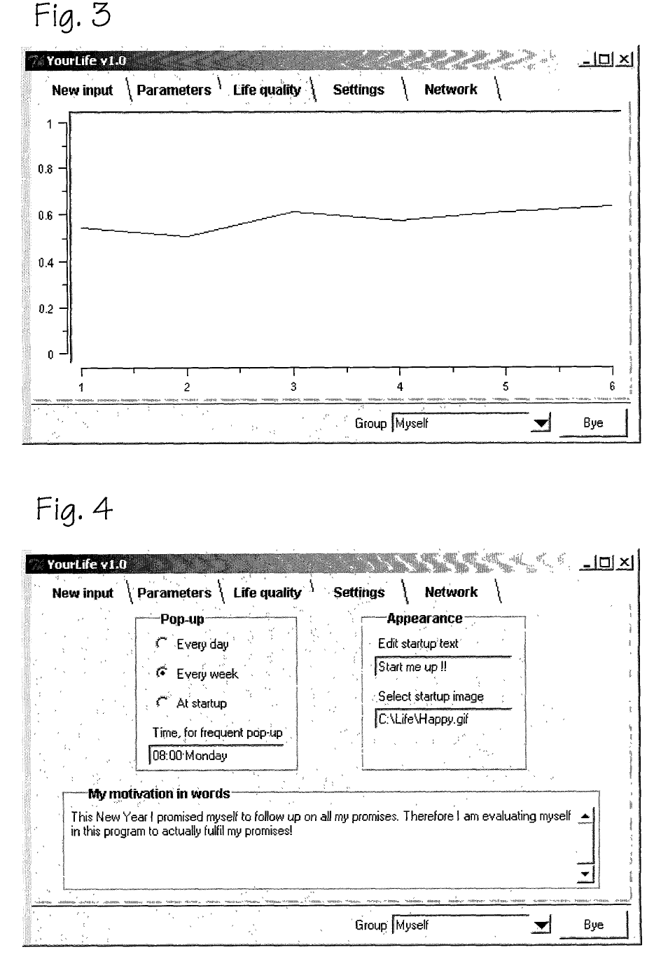

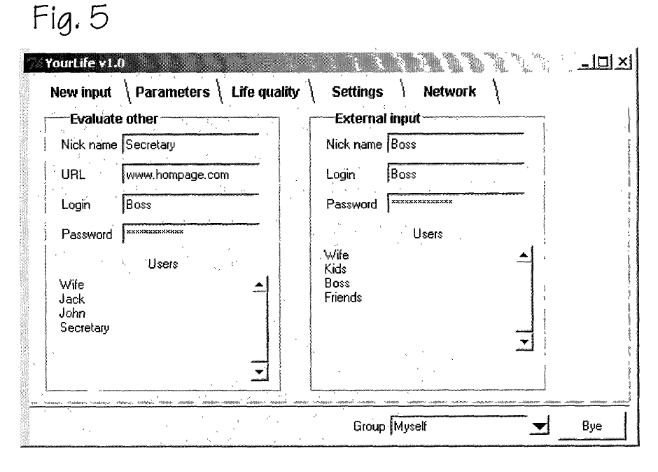

The software program displays five different on-screen windows on the computer screen, indexed by five tabs: New Input (FIG. 1), Parameters (FIG. 2), Life Quality (FIG. 3), Settings (FIG. 4) and Network (FIG. 5). The user brings a particular screen to the forefront by clicking on the desired “tab” using a mouse. The tab “New input” displays the user interface allowing the user to carry out an evaluation of the selected set of parameters. The tab “Parameters” displays a plotted graph of the progress of the parameters evaluated. The tab “Life quality” displays a plotted graph of the calculated success factor and its development. The tab “Settings” displays the user interface allowing the user to change the program settings. Finally, the tab “Network” displays the user interface allowing the user to chose to be evaluated by others or to evaluate others.

FIG. 1 illustrates an exemplary screen for allowing the user to select the parameters ultimately used to calculate a success factor or “quality of life”. A user is asked to select or define a set of criteria, hereinafter referred to as parameters, by which to benchmark his or her or another person's quality of life. The number of parameters is variable, preferably with at least two parameters being assessed. The parameters designated to assess quality of life can be user defined, pre-defined, or a combination of both. For example, parameters may relate to religious, philosophical, job-performance related, family life, or social aspects of quality of life of the person being evaluated. A particular set of parameters may relate to an individual's New Year's resolutions, including the top ten things that the individual wanted to improve in his life that upcoming year. Another set of parameters might include the ten areas of improvement that a boss identified on an employee's yearly eventuation. As shown in FIG. 1, “Control parameters” allow the user to add, remove, or clear parameters so as to tailor the program for his specific goals. The selected set of parameters are stored on the hard disk of the PC.

An example of a selected set of parameters is shown in the table below, and also listed under “Today's parameters” scrollable window in FIG. 1.

| Nr. | Parameters |
|---|---|
| P₁ | Sports activities |
| P₂ | Happy mood, I have stopped to be annoyed |
| P₃ | Family harmony |
| P₄ | Satisfactory working day |
| P₅ | Feeling fine, not ill |
| P₆ | Eating good food |
| P₇ | No smoking |
| P₈ | No alcohol |
| P₉ | Telling the truth |

The fulfillment of each parameter may be entered by clicking a box associated with the respective parameter. The user may also click on-screen buttons, may use keyboard commands, use a pen with a palm pilot or others means for selecting the respective parameters. In this example, the user “myself”, has at the moment of evaluation reported positively that he has engaged in sport activities that day, was in a happy mood, had a satisfactory working day, and had not smoked. The user reported negatively on the other parameters: family harmony, feeling fine, eating good food, no alcohol, and telling the truth.

Depending of the type of criterion or parameter, the evaluation does not have to be limited to an absolute yes or no as shown either clicked or not clicked. A range of gradually more confirming answers such as never—seldom—sometimes—often—all the time may be associated with a parameter or alternatively a percentage may be associated with a parameter.

“Group” (described in detail below in FIG. 5), indicates which user is selecting the parameters. Here, the individual selecting the parameters is the individual being evaluated (“myself”). In alternate embodiments, parameters are used to evaluate another or are evaluated by others and imported. The parameter evaluation is stored on the hard disk or other memory of the PC and sent via a network to the PC or other data processor of the person to be evaluated or alternatively to a central server.

FIG. 2 illustrates an exemplary screen displaying the plotted graph of the parameter values. Parameters P₁ through Pₙ are listed on the right of the screen. Once the parameters are evaluated by the user interface as described, the software calculates an average value Pᵢ for each parameter “i”: P₁, P₂, P₃, . . . Pᵢ . . . Pₙ. In a preferred embodiment, a damping function is used:

Pᵢ^{new}=Pᵢ^{old}*0.8+0.2*Pᵢ

where the new average value of Pᵢ^{new} is calculated from the former one Pᵢ^{old} and the newly evaluated value of Pᵢ. As soon as Pᵢ^{new} has been calculated, it is set equal to Pᵢ^{old} which is used in the equation the next time Pᵢ is evaluated. This formula dampens out large variations, and is not a real historical average referred to in mathematics as “arithmetic mean”. It is possible to use the arithmetic mean instead, but by taking into account the complete history of the parameter evaluation, new trends will be completely dampened out and thus not recognizable. According to a preferred embodiment, the value for Pᵢ could be set to 0.5 at the first evaluation where it is possible for Pᵢ to vary between 0 and 1. In the example shown in FIG. 1, 1 was given to all parameters selected (i.e. the activity or the like took place) and 0 was given to all parameters not selected (i.e. the activity or the like did not take place). Alternatively the first average value Pᵢ^{old} is set equal to the first evaluation value. An example of this procedure follows, where P₁ represents “Sport activities”:

| | P₁^{old} | P₁ | P₁^{new} = P₁^{old} * 0.8 + 0.2 * P₁ |
|---|---|---|---|
| 1 | 0.5 | 1 | 0.6 |
| 2 | 0.6 | 1 | 0.68 |
| 3 | 0.68 | 1 | 0.744 |
| 4 | 0.744 | 1 | 0.7952 |
| 5 | 0.7952 | 0 | 0.63616 |
| 6 | 0.63616 | 0 | 0.508928 |
| 7 | 0.508928 | 1 | 0.6071424 |

The development of P₁ is plotted on a graph including the previous values over time as shown in FIG. 2. The procedure is applied to all “n” parameters (P₁ through Pₙ). The numbers 0 through 1 on the y axis represent the value of Pᵢ^{new}, here P₁^{new}, and the numbers 1 though 7 on the x axis represent the number of times the test was run. The same calculation is carried out for the other parameters P₂ through Pₙ in the selected set.

Another method, to be used with or in lieu of the above method, is especially useful when the user is not the person to be assessed. The selected parameters, or some of them, are given values as a number between 0 and 1 or in percentage between 0% and 100%. Below is an example of the calculation of one of the parameters from one assessment to another.

| | P₁^{old} | P₁ | P₁^{new} = P₁^{old} * 0.8 + 0.2 * P₁ |
|---|---|---|---|
| 1 | 0.5 | 0.8 | 0.56 |
| 2 | 0.56 | 0.9 | 0.628 |
| 3 | 0.628 | 0.1 | 0.502 |
| 4 | 0.502 | 0.9 | 0.582 |
| 5 | 0.582 | 0.9 | 0.646 |
| 6 | 0.646 | 0.9 | 0.694 |

The same calculation is carried out for the other parameters in the selected set.

To start the method, a value for P₁^{old} of about 0.5 is preferred in order to avoid extremely negatively biased (in case of starting with a P₁^{old} is close to 0) or extremely positively biased (in case of starting with a P₁^{old} is close to 1) first results.

FIG. 3 illustrates an exemplary screen displaying the plotted graph of a calculated success factor value or “quality of life”. According to a preferred embodiment, a success factor SF measuring the individual's quality of life, is derived from all “n” parameters and is calculated according to the formula:

SF⁼ⁿ√(P₁^{new}*P₂^{new}* . . . *Pᵢ^{new}* . . . *Pₙ^{new})

The success factor is plotted in a graph including the previous values over time as shown in FIG. 3. The numbers 0 through 1 on the y axis represent the value of success factor SF and the numbers 1 though 6 on the x axis represent the number of times the test was run. The closer the success factor or SF is to 1, the higher the individual's score or overall “quality of life”.

FIG. 4 displays the user's operational settings and allows the user to make adjustments to those settings. “Pop-up” allows the user to select how often he wishes to evaluate his parameters, selections here shown as “Every day”, “Every week”, “At startup”, or “Time, for frequent pop up”. “Appearance” allows the user to alter text such as “Edit startup text” and “Select startup image”. Finally, the user can input a motivational statement (“My motivation in words”) to use as inspiration or as a reminder, here as shown the user entering his New Years Resolution.

FIG. 5 displays the user's network and allows the user to select network options. “Evaluate others” gives the user the opportunity to evaluate others. In this example, the user is a boss, who wants to evaluate his secretary, and does so by entering in the nick name of the person to be evaluated, “secretary”, entering the URL address, entering in his Login id “boss” and his password. “External input” allows the user to receive input from others. Here, the user wants to receive information from nick name “boss”.

When the user chooses to evaluate others or to receive external input, the system can also be configured to operate with several data processors that are connected, via a local network such as an intranet, a public network such as the internet, a public telephone network or a cellular network. For example, where the user is a superior and wishes to evaluate his subordinate with respect to parameters relating to job-performance, the results may be shown directly on the subordinate's PC or other form of data processor. The request for evaluating a set of parameters may alternatively be sent as text message, such as an SMS message to a mobile phone. The user sends a reply SMS with the parameter evaluation back. This system may be used to evaluate and give feedback to a person functioning in a group, such as a workplace, a family or a sports team. The software is advantageously integrated in an e-mail software such as Lotus Notes® or Microsoft Outlook®.

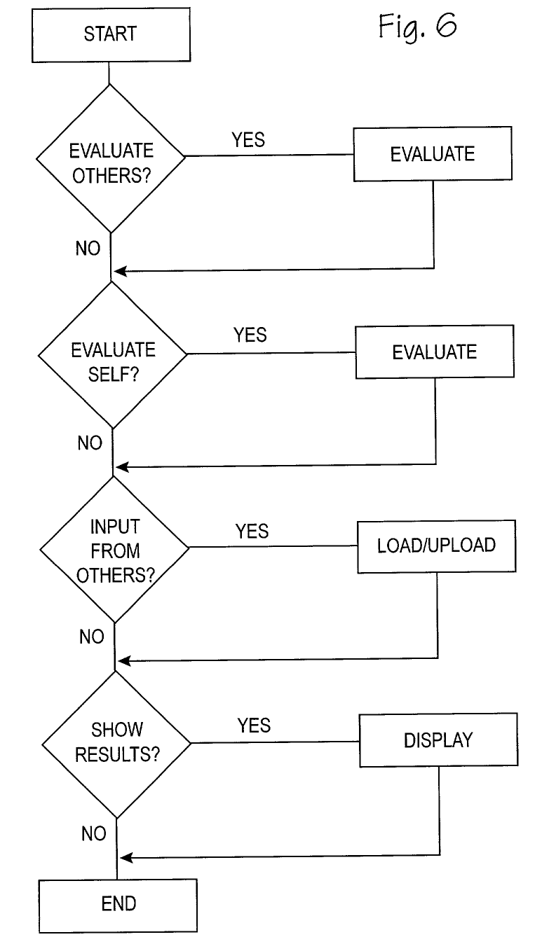

FIG. 6 illustrates one embodiment of the operational flow of the software used to collect parameter values for the calculation of Pᵢ^{new}. Upon start up of the PC, the program automatically starts. The user is asked if parameters for other persons need to be evaluated. If yes, the software activates a screen display in which the selected set of parameters for that person is listed (FIG. 1). Fulfillment of parameters is entered by ticking boxes associated with the relative parameter. The parameter evaluation is stored in a hard drive or other memory of the PC and sent via a network to the PC or other data processing means of the person to be evaluated or alternatively to a central server. If no evaluation of other persons is required, the software will jump to the next step.

In the next step, the user is asked if his or her own set of parameters needs to be evaluated. If yes, the parameter evaluation as described above is carried out. New parameters may be added and old parameters may be deleted in this step by clicking on buttons under “control parameters”. If no evaluation of the user's own set of parameters is required, the software will jump to the next step.

Next, the user is asked if parameter evaluation provided by others are to be obtained. If yes, the PC will connect to a network and obtain available parameter evaluations from the data processors of the other persons providing evaluation or from a server on which evaluations are temporarily stored. If no evaluations by others are to be obtained, the software will jump to the next step, in which the software calculates P₁ through Pₙ and plots the information as shown in FIG. 2.

Although the present invention has been described in detail for purpose of illustration, it is understood that such detail is solely for that purpose, and variations can be made therein by those skilled in the art without departing from the scope of the invention.

Thus, while the preferred embodiments of the devices and methods have been described in reference to the environment in which they were developed, they are merely illustrative of the principles of the inventions. Other embodiments and configurations may be devised without departing from the spirit of the inventions and the scope of the appended claims.

We claim:

1. A system for assessing and monitoring quality of life comprising a data processing means, a data input interface and a data output interface, said system comprising:
means for requesting entry of a selected set of parameters for evaluating quality of life,
means for storing said selected set of parameters,
means for requesting, repeatedly over time, evaluation of each of the parameters in the selected set of parameters, and
means for displaying the development over time of the evaluation of the parameters.

2. A system according to claim 1, further comprising:
means for calculating the development of the parameter evaluation by the function
Pᵢ^{new}=Pᵢ^{old}*0,8+0,2*Pᵢ
wherein Pᵢ is the present value, Pᵢ^{old} is the previous value and Pᵢ^{new} is the newly calculated value of one of a plurality of parameters comprising the selected set of parameters.

3. A system according to claim 2, further comprising:
means for calculating a success factor from the evaluated parameters and means for displaying a graph showing the development of said success factor over time.

4. A system according to claim 3, wherein said means for calculating the success factor calculates the success factor in accordance with the formula
ⁿ√(P₁^{new}*P₂^{new}* . . . *Pᵢ^{new}* . . . *Pₙ^{new})
wherein P₁^{new}, P₂^{new}, . . . , Pᵢ^{new}, . . . , Pₙ^{new} are the newly calculated values of parameters P₁, P₂, . . . , Pᵢ, . . . , Pₙ, comprising the selected set of parameters

5. A system according to claim 1, wherein the data processor is connected to other data processors via a network, said system further comprising means for sending repeatedly over time the selected set of parameters to another data processor connected to said network, and means for requesting to receive in return an evaluation of the selected set of parameters.

6. A system according to claim 1, wherein a set of parameters for evaluating another person is stored on the data processor, and wherein the data processor is connected to other data processors via a network, said system further comprising:
means for requesting repeatedly over time to evaluate each of the parameters in the set for evaluating the other person, and
means for sending the parameters evaluation for the other person to a data processor of the other person or to a server to which the other person has access.

7. A method for assessing and monitoring quality of life by means of a data processing means, a data input interface and a data output interface, wherein the data processing means is provided with software for executing the steps of:
requesting entry of a set of parameters for benchmarking quality of life;
storing said set of parameters;
requesting, repeatedly over time, evaluation of each of the parameters in the set; and
displaying the development over time of the evaluation of the parameters.

8. A method according to claim 7, wherein the development of the parameters evaluation is calculated by the function
Pᵢ^{new}Pᵢ^{old}*0,8+0,2*Pᵢ;
wherein Pᵢ is the present value, Pᵢ^{old} is the previous value and Pᵢ^{new} is the newly calculated value of one of a plurality of parameters

9. A method according to claim 8, wherein a success factor is calculated from the evaluated parameters and displayed in a graph showing the development of said success factor over time.

10. A method according to claim 9, wherein said success factor is calculated in accordance with the formula
ⁿ√(P₁^{new}*P₂^{new}* . . . *Pᵢ^{new}* . . . *Pₙ^{new})
wherein P₁^{new}, P₂^{new}, . . . , Pᵢ^{new}, . . . , Pₙ^{new} are the newly calculated values of parameters P₁, P₂, . . . , Pᵢ, . . . , Pₙ comprising the selected set of parameters.

11. A method according to claim 7, wherein said data processor is connected to other data processors via a network, said method further comprising the step of sending repeatedly over time the selected set of parameters to another data processor connected to the network, and requesting to receive in return an evaluation of the set of parameters.

12. A method according to claim 7, wherein a set of parameters for evaluating another person is stored in the data processor and wherein the data processor is connected to other data processors via a network, further comprising the steps of
requesting repeatedly over time to evaluate each of the parameters in the set for evaluating the other person, and
sending the parameters evaluation for the other person to a data processor of the other person or to a server to which the other person has access.
